(19) United States
(12) Patent Application Publication
(10) Pub. No.: US 2006/0047561 A1
(43) Pub. Date: Mar. 2, 2006

(54) Systems and methods for providing operational risk management and control

(75) Inventor: Charles Nicholas Bolton, Zurich (CH)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: UBS AG

(21) Appl. No.: 10/927,035

(22) Filed: Aug. 27, 2004

(51) Int. Cl. G06F 17/30

(52) U.S. Cl. 705/10

(57) ABSTRACT

Systems and methods are disclosed for providing a framework for operational risk management and control. In the disclosed systems and methods, roles and responsibilities may be defined for at least one function of an enterprise, and at least one control objective may be defined to identify at least one operational risk associated with at least one of the roles and responsibilities. Further, at least one control standard may be defined to describe an activity to be taken to achieve the at least one control objective. Finally, certification may be performed to certify adherence to the at least one control standard. In one embodiment, a periodic certification process may be implemented to determine compliance with the at least one control standard by a person responsible for the performance of the control standard.

### BACKGROUND OF THE INVENTION

I. Field of the Invention

The present invention generally relates to systems and methods for providing operational risk management and control. More particularly, the invention relates to an internal framework for managing and controlling the operational risk of an enterprise in compliance with, for example, governmental or financial regulations.

II. Background Information

Operational risk management and control is a process that allows control failures within an enterprise to be identified and assessed and the appropriate actions necessary to address them to be determined. In some situations, such processes are required by governmental or financial regulations, such as the Sarbanes-Oxley Act of 2002 Section 404 (“SOX 404”) and the Basel II accord. For example, SOX 404 requires companies to maintain internal controls over financial reporting in order to ensure the integrity of financial statements. Per SOX 404, companies must assess the effectiveness of their internal controls and provide evidence, including documentation, to support the assessment. In addition, external auditors must make an independent attestation report. This attestation report (produced after an audit of internal control over financial reporting) must include not only an assessment of the management processes, but also of internal control over financial reporting itself.

The U.S. Securities and Exchange Commission (SEC) has developed specific rules to implement the SOX 404 legislative requirements. The key impacts of these rules on the nature of the assessment process are as follows. First, SOX 404 does not require a specific comprehensive assessment for legal entities (i.e., enterprises.) Instead, the assessment is for the legal entity or enterprise as a whole. This is in contrast to Section 302 of SOX, which requires specific individuals in legal entities to report on disclosure controls and procedures for those entities. Also, SOX 404 assessments must be made “as of” the date of the end of the relevant financial reporting period and for the entire period covered by the annual report (e.g., as of 31 December and for the entire year for calendar year reporting). In addition, the SOX 404 assessment is distinct from the signing of any SOX section 302/404/906 certification statements, although it is a required element before the certification can be signed. Thus, the assessment and the certification signing do not necessarily have to be performed by the same individuals.

While the SEC has developed specific rules as described above, these rules do not specify how to structure an internal control framework in order to undertake an assessment of internal control over financial reporting. Instead, the SEC rules reference Internal Control—An Integrated Framework, a report produced by the Committee of Sponsoring Organizations of the Treadway Commission (“COSO Framework”) and other equivalent control frameworks.

Furthermore, SOX 404 rules do not specify how the assessment of internal control over financial reporting should actually occur. Some guidance can be found in the rules developed by the U.S. Public Company Accounting Oversight Board (PCAOB) that specify how auditors should conduct an audit of internal control over financial reporting. The PCAOB SOX 404 rules describe a process that includes an assessment of design and operating effectiveness, but allow a large amount of discretion in how this should be implemented. The PCAOB SOX 404 rules also specify the information that must be supplied by management to the external auditors.

Moreover, some enterprises, such as banks for example, may be regulated by national banking regulations based on the standards promulgated by the Basel Committee. Established by the central-bank Governors of the Group of Ten countries at the end of 1974, the Basel Committee meets four times a year in Basel, Switzerland, to review and endorse new standards for international banking regulation. The Basel Committee recently endorsed the publication of International Convergence of Capital Measurement and Capital Standards: a Revised Framework, the new capital adequacy framework, commonly known as the Basel II accord which includes a specific requirement regarding operational risk management and control. Although closely aligned in spirit, SOX 404 and Basel II do have some differences. However, the differences are not so great that they merit two separate compliance processes. For example, Basel II focuses on risk, while SOX 404 focuses on financial reporting.

In view of the foregoing, there is a need for systems and methods for providing operational risk management and control. Furthermore, there is a need for providing an internal framework that allows control failures within an enterprise to be identified and assessed. Moreover, there is a need for systems and methods for providing operational risk management and control consistent with governmental or financial regulations, such as SOX 404 and the Basel II accord, for example.

### SUMMARY OF THE INVENTION

Consistent with embodiments of the present invention, systems and methods are disclosed for providing operational risk management and control. In accordance with one embodiment, an internal framework is provided for identifying and assessing the operational risk of an enterprise. Such a framework may be computerized or software-implemented and used by an enterprise for complying with governmental or financial regulations, for example. Embodiments of the invention also relate to systems and methods for managing the workflow associated with the aforementioned assessment process and to store the documentation for internal review, external reviews and/or financial reporting.

In accordance with one embodiment of the invention, a method for providing operational risk management and control may comprise defining roles and responsibilities for at least one function of an enterprise, defining at least one control objective identifying at least one operation risk associated with at least one of the roles and responsibilities, defining at least one control standard describing a measure to be taken to achieve the at least one control objective, and certifying adherence to the at least one control standard to meet the at least one control objective for the at least one role and responsibility.

Quality metrics (key risk indicators) and other event data (both internal and external) may also be collected to measure the quality of the compliance with respect to the control standards and to assess risk. All of this information may be evaluated within a cross-function governance structure to allow for appropriate risk management and control decisions to be taken and the reporting of information to, for example, senior management.

According to another embodiment, a system for providing operational risk management and control may comprise a memory for maintaining a database and a processing unit coupled to the memory, wherein the processing unit may be operative to set roles and responsibilities for at least one function of an enterprise, set at least one control objective identifying at least one operation risk associated with at least one of the roles and responsibilities, set at least one control standard describing a measure to be taken to achieve the at least one control objective, and certify adherence to the at least one control standard to meet the at least one control objective for the at least one role and responsibility.

The above-described system may be operative to set at least one quality metric related to the at least one control standard and to measure the quality of the performance of the control standard using the at least one quality metric. Furthermore, the exemplary system may be operative to collect internal and/or external event information used in the management and control of operational risk and to produce reports that facilitate the actions necessary to manage and control operational risk.

In accordance with yet another embodiment, a computer-readable medium is provided that stores a set of instructions which when executed performs a method for providing operational risk management and control. The method may comprise setting roles and responsibilities for at least one function of an enterprise, setting at least one control objective identifying at least one operation risk associated with at least one of the roles and responsibilities, setting at least one control standard describing a measure to be taken to achieve the at least one control objective, and certifying adherence to the at least one control standard to meet the at least one control objective for the at least one role and responsibility.

The above-described method may involve the setting of at least one quality metric related to the at least one control standard in order to measure the quality of the performance of the control standard using the at least one quality metric. Furthermore, the exemplary method may comprise collecting internal and external event information used in the management and control of operational risk and producing reports that facilitate the actions necessary to manage and control operational risk.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a diagram of an exemplary operational risk management and control process, consistent with an embodiment of the present invention;

FIG. 2 is a diagram of an exemplary cross-functional governance structure, consistent with an embodiment of the invention;

FIG. 3 is a block diagram of an exemplary system for providing operational risk management and control, consistent with an embodiment of the present invention;

FIG. 4 is a flow chart of an exemplary method for providing operational risk management and control, consistent with an embodiment of the present invention; and

FIGS. 5A through 5D show exemplary screen shots which may be provided as part of a self-certification process in which users are solicited to an answer to control standard questions.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention may provide for operational risk management and control. As further disclosed herein, such systems and methods may be used by enterprises (e.g., small businesses, large corporations, institutions, etc.) to manage and control their operational risk. “Operational risk” may relate to the risk of loss resulting from, for example, inadequate or failed internal processes, people and/or systems, or from deliberate, accidental or natural external causes.

In accordance with one embodiment, an internal framework is provided for managing and controlling operational risk. Such a framework may be used by an enterprise for complying with governmental or financial regulations, for example. Embodiments of the invention also relate to systems and methods for managing the workflow associated with such a management and control process and to store the documentation for internal review, external reviews, and/or financial reporting.

By way of example, an operational risk framework may be provided that facilitates risk management and control. The operational risk framework may comprise software and/or computer-implemented components that provide much of the basic infrastructure required to comply with, for example, SOX 404 requirements on internal control over financial reporting. Furthermore, the operational risk framework, and its outputs, may be used to meet other requirements, such as the Basel II operational risk qualitative requirements under the advanced measurement approach (AMA) framework.

In accordance with an exemplary embodiment of the invention, a method is provided for operational risk management and control. The method may include defining roles and responsibilities, and control objectives and standards for personnel within each business function or group of an enterprise. The roles, responsibilities and standards setting may be reviewed, agreed upon, and documented and/or otherwise recorded (e.g., stored in a database). The exemplary method may also include certifying activities of the personnel according to the control objectives and standards. As disclosed herein, certification may require that individuals perform self-certification of their activities according to their assigned roles and responsibilities. Self-certification may be made against the control standards, with the responses of each self-certifier being reviewed and approved by a manager or other designated personnel. Quality metrics (key risk indicators) and internal event data may also be collected to help measure the quality of the compliance with the control standards. External events also may be monitored for use in risk assessments. Furthermore, all of this information may be evaluated within a cross-function governance structure to allow for appropriate risk management and control decisions to be taken and the reporting of information to senior management.

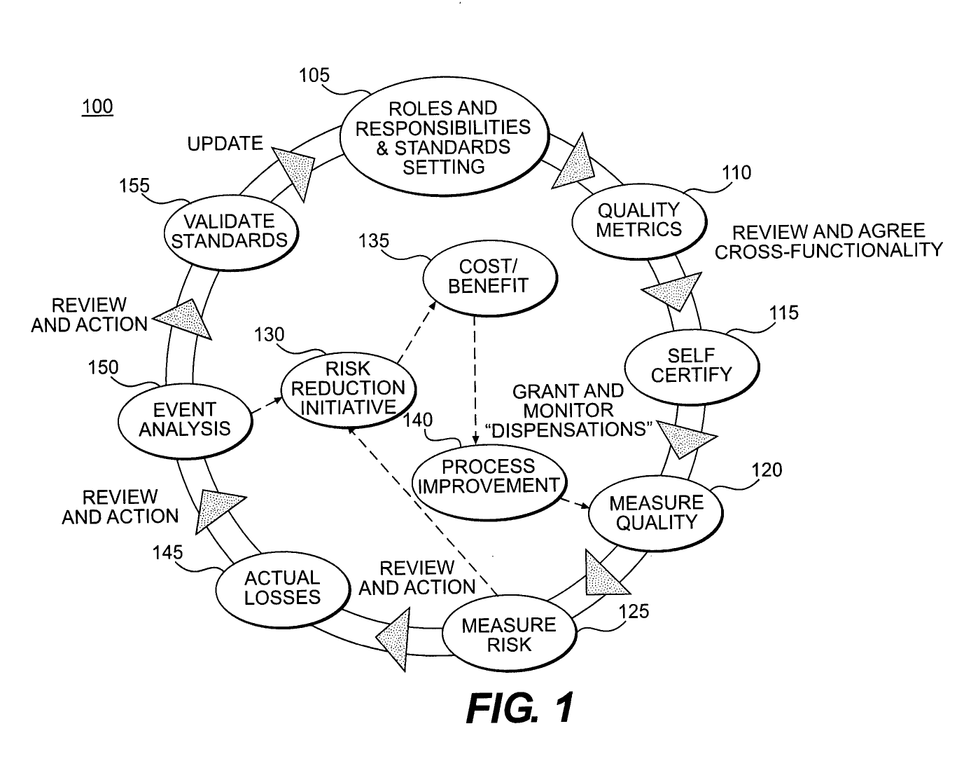

Referring now to FIG. 1, a diagram of an exemplary operational risk management and control process 100 is illustrated, consistent with an embodiment of the present invention. When implemented by an enterprise, process 100 may provide a framework for facilitating risk management and control. As further described below, process 100 may be built around a set of requirements or standards, including: roles and responsibilities; control objectives; control standards; and quality metrics (see FIG. 1). These items may be reviewed, agreed upon and documented by selected or authorized individuals within an enterprise. Consistent with an aspect of the invention, the documentation of such requirements may be facilitated by, for example, a database that stores the requirements for risk management and control.

In accordance with one embodiment, each business group or unit of the enterprise may be given the task of reviewing and discussing standards setting, compliance to standards and quality monitoring processes, and action recommendations. Collectively, these business groups may cover all of the main functions (e.g., operations, finance, legal, risk, IT, human resources, etc.) of the enterprise. In addition, a cross-function governance structure of individuals or function experts may be instituted to oversee the implementation and operation of process 100. Such a structure may comprise one or more committees with representatives from all functions that are required to certify their activity against control standards. In addition to standards and requirements setting, reporting mechanisms may be defined to allow risks and exceptions to be reported and managed through the governance structure.

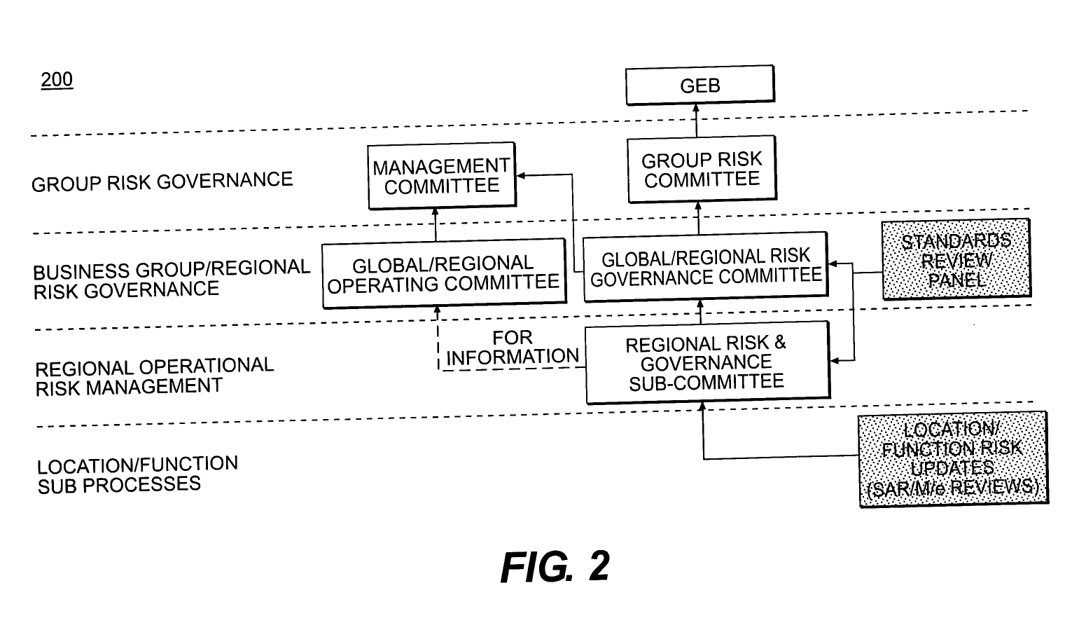

By way of example, FIG. 2 illustrates a cross-function governance structure 200, consistent with an embodiment of the invention. As shown in the example, the governance structure may comprise several levels of committees or sub-committees. These levels may be arranged in a hierarchy to provide governance from location/function sub processes, to regional operational risk management, to business group/regional risk governance, and finally to group risk governance for the enterprise, including the ultimate executive authority for the enterprise (in the diagram in FIG. 2, the GEB or Group Executive Board).

Referring again to FIG. 1, part of the documentation requirements may include evaluating and defining roles and responsibilities (stage 105). As further described below, roles and responsibilities may define the distinct tasks that individuals within each business function (e.g., operations, finance, legal, risk, IT, human resources, etc.) are responsible for. Roles and responsibilities may indicate where a function begins and ends, as well as where the function relies on other functions.

In addition to defining roles and responsibilities, standard setting may be performed at stage 105. Any number of standards may be defined and documented. In general, standards may provide risk-based controls that facilitate the identification of risk areas in an enterprise. Standards may also specify what actions should be taken to reduce risk. In one embodiment, standards are set by functional experts and provide clearly defined segregation of duties between functions. Further, standard setting may include defining control objectives and control standards. A control objective may identify an operational/control risk that a function is trying to address through the application of specific controls (i.e., the control standards). A control standard may provide specific expectations that should be met in the performance of a function's activities with regard to operational risk control. Control standards may define the control that should be performed without specifying how that control is to be accomplished (i.e., they may be independent of the process).

As shown in FIG. 1, quality metrics may also be determined and set (stage 110). Quality metrics may function to provide key risk indicators for an enterprise. In general, a quality metric may provide a measure of specific trackable event(s) and help to provide an indication of potential risk levels related to the performance of control standards in a particular business function. Quality metrics may also provide information that may help identify when further investigation into potential failures in controls is warranted.

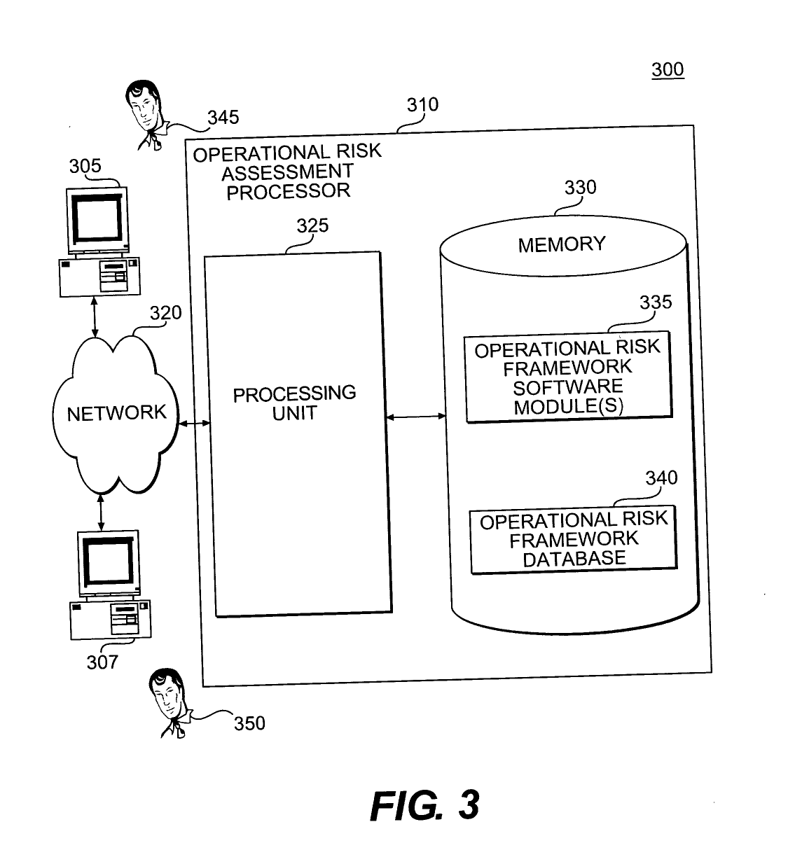

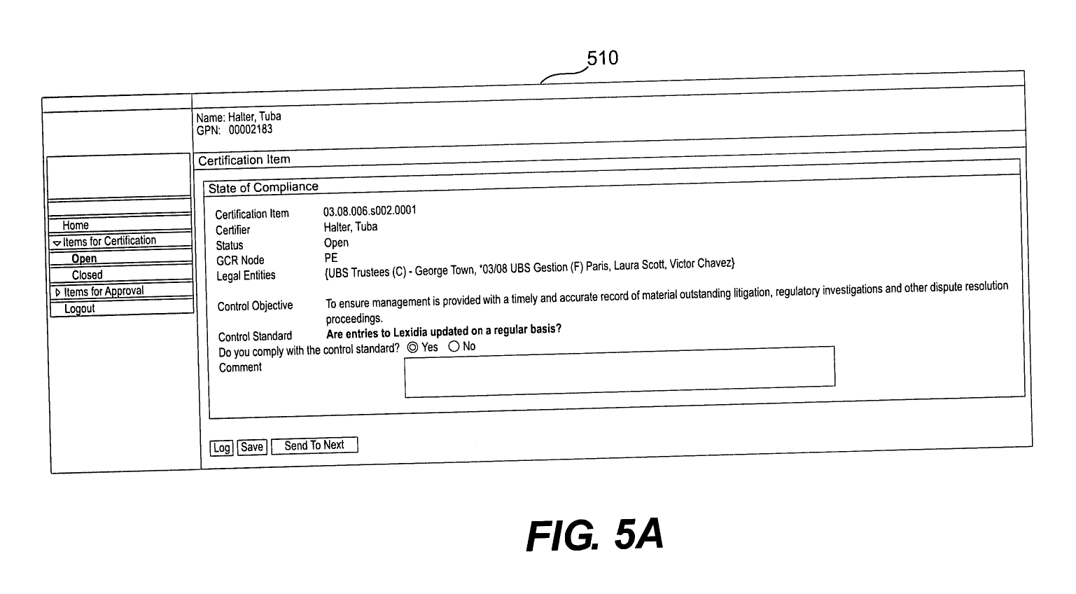

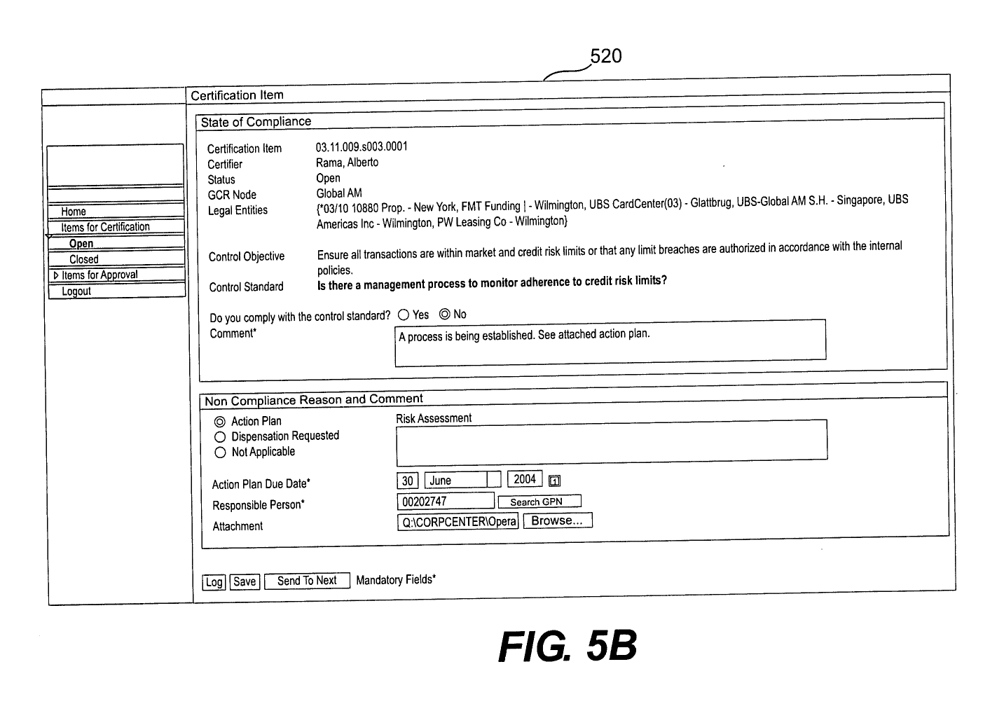

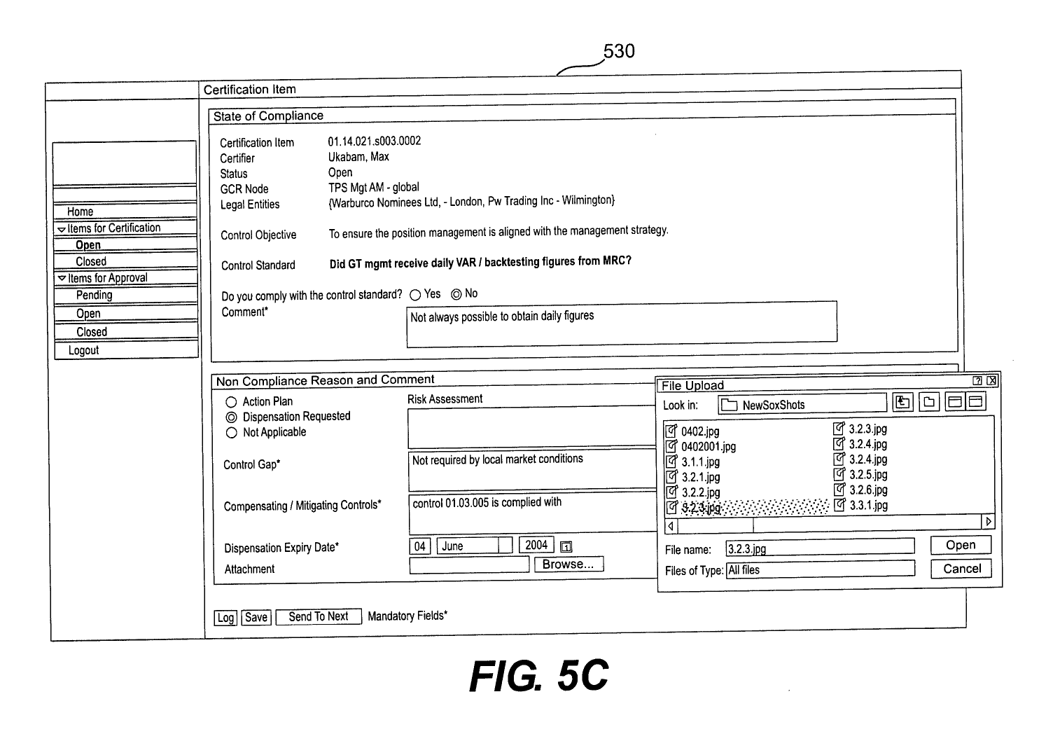

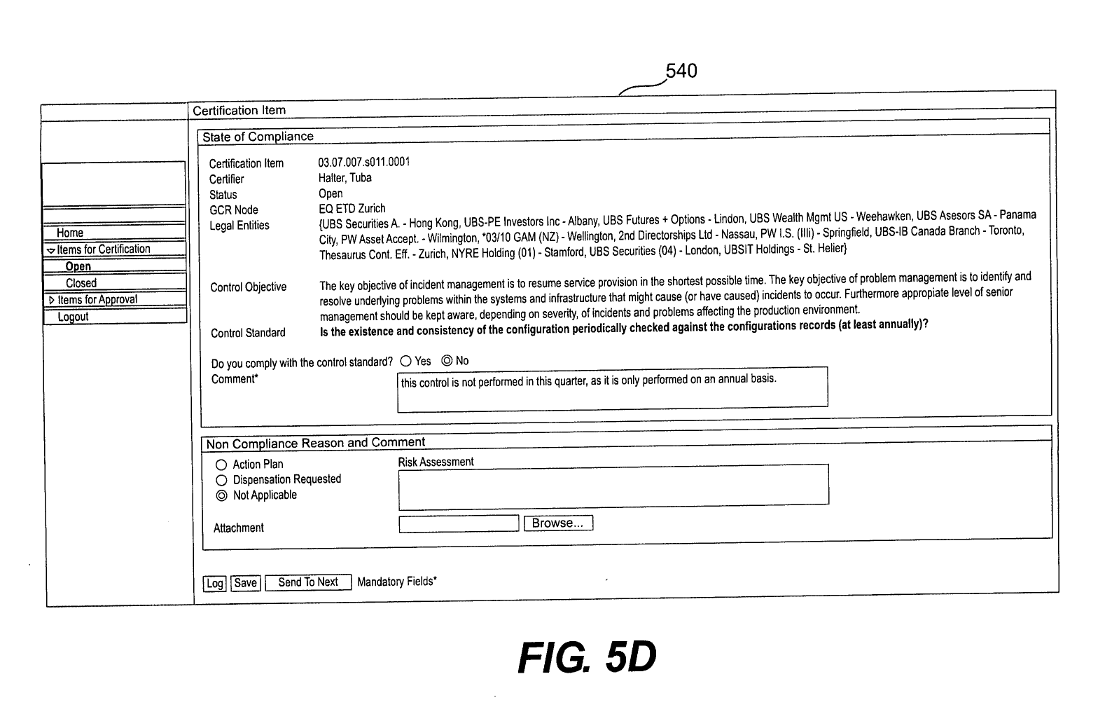

Another key element of process 100 is certification. As shown in FIG. 1, certification of control standards may be implemented through self-certification (stage 115). Self-certification may allow employees of an enterprise to compare current processes against the control standards and to confirm that they are being adhered to. As further disclosed herein, personnel that self-certify their activity may be required on a periodic basis (e.g., quarterly) to respond to control standard questions. Such responses may be collected and analyzed using a computerized system (see, e.g., FIG. 3) that includes, for example, graphical user interfaces (GUIs) (see, e.g., FIGS. 5A-5D).

Managers or other designated individuals of an enterprise may review the answers to assess the performance of the controls. This step may be performed as part of stage 115 or as part of a general quality review (stage 120). Any areas of non-compliance should be highlighted as part of this process. Where risk control processes are found to be lacking or informal (stage 125), appropriate action may be taken. This may include one or more of the following: filling the control gaps through the development of additional control standards (stage 130); accepting the risk associated with the control gap based on a cost/benefit analysis after a dispensation request (stage 135); and/or taking any other or additional actions to improve control processes (stage 140). Examples of additional actions include adding more resources (human or technology-based) to improve the control process or monitoring capability, or changing business operation procedures.

To supplement self-certification where compliance is found, the quality of that compliance may be assessed (stage 120). This may be performed within every business function by tracking the indicators (quality metrics) in each function on a periodic (e.g., monthly) basis. Consistent with an embodiment of the invention, the quality metrics may be specific quantitative or qualitative measure of performance. Operational risk may be measured through this process (stage 125), resulting in further review and action (stages 130, 135 and 140).

In addition to quality measurement through the use of self-certification and metrics, other risk assessment processes may also occur. For example, internal event data and actual operational risk data (both profits and losses) may be collected (stage 145). Such data may be collected periodically (e.g., daily) to identify trends and, additionally, to determine a quantitative assessment of operation risk levels. External events, where sufficient information can be obtained, may also be evaluated (stage 150). Such data may be compared against internal processes to measure and assess susceptibilities. Based upon the event analysis, risk reduction measures may be taken (stage 130), including a cost/benefit analysis (stage 135), and process improvements may be identified and/or implemented (stage 140).

The combination of information described-above may be collected and discussed within a cross-functional governance structure (see, e.g., FIG. 2). The governance structure may be responsible for the identification and assessment of operational risk, making recommendations for operational risk control and mitigation, and determining what information should be reported on for additional consideration by, for example, senior management at the business group or group level. Part of this process may also include the review and validation of standards (stage 155), to fully implement process 100 into an enterprise's life cycle. Validation may require, where appropriate, the modification or re-defining of standards.

In one embodiment, the monitoring, review, action, and reporting mechanisms described above are implemented, while ensuring the integrity of one or more of the following elements: the data inputs (self-certification results; quality metrics; event data) used in the risk assessment process; the actual process of event analysis and risk reduction initiatives including the cost-benefit analysis conducted; and the reporting mechanism used to raise issues to senior management. To do so, this may require the establishment of an independent monitoring process. Such a process may include an independent review procedure within a function, an internal audit reviews, and/or a governance structure around the control framework (such as the exemplary governance structure of FIG. 2).

Embodiments consistent with the invention comprise computer-implemented systems for operational risk management and control. Such systems may include a memory for maintaining a database and a processing unit coupled to the memory. As disclosed herein, the database may be utilized to record and set requirements, standards and/or quality metrics (see, e.g., stages 105-110 of FIG. 1). In addition, the processing unit may be operative to facilitate the documentation process, as well as the certification and analysis stages.

By way of example, the processing unit may be operative to set roles and responsibilities for at least one function of an enterprise, and set at least one control objective identifying at least one operation risk associated with at least one of the roles and responsibilities. Furthermore, the processing unit may be operative to set at least one control standard describing a measure to be taken to achieve the at least one control objective and to certify adherence to the at least one control standard to meet the at least one control objective. Additionally, the processing unit may be operative to set at least one quality metric related to the quality of the at least one control standard and to measure quality using the at least one quality metric. The system may also be operative to collect internal and/or external event information used in the management and control of operational risk and to produce reports that facilitate the actions necessary to management and control operational risk.

Consistent with an embodiment of the present invention, the aforementioned memory, processing unit, and other components may be implemented in an operational risk management and control system, such as the exemplary operational risk management and control system 300 of FIG. 3. Any suitable combination of hardware, software and/or firmware may be used to implement the memory, processing unit, or other components. By way of example, the memory, processing unit, or other components may be implemented with one or more processors (305, 307, 310, etc.) in combination with the other components of system 300. The aforementioned system and processors are exemplary and other systems and processors may comprise the aforementioned memory, processing unit, or other components, consistent with embodiments of the present invention.

Furthermore, while embodiments of the invention are described with reference to software executed by a processor, the invention may also be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer, a server, a workstation, hand-held computer or in any other circuits or systems.

Referring again to FIG. 3, exemplary system 300 is provided in which the features and principles of the present invention may be implemented. As shown, system 300 may include one or more processors 305, 307, and 310, and a network 320. Processors 305 and 307, as well as other processors, may be connected via network 320 to processor 310, which may be configured as a “central” processor or server. One or more users 345, 350, etc. may access processors 305, 307, etc. to perform features related to the invention, including standard setting, self-certification and risk analysis.

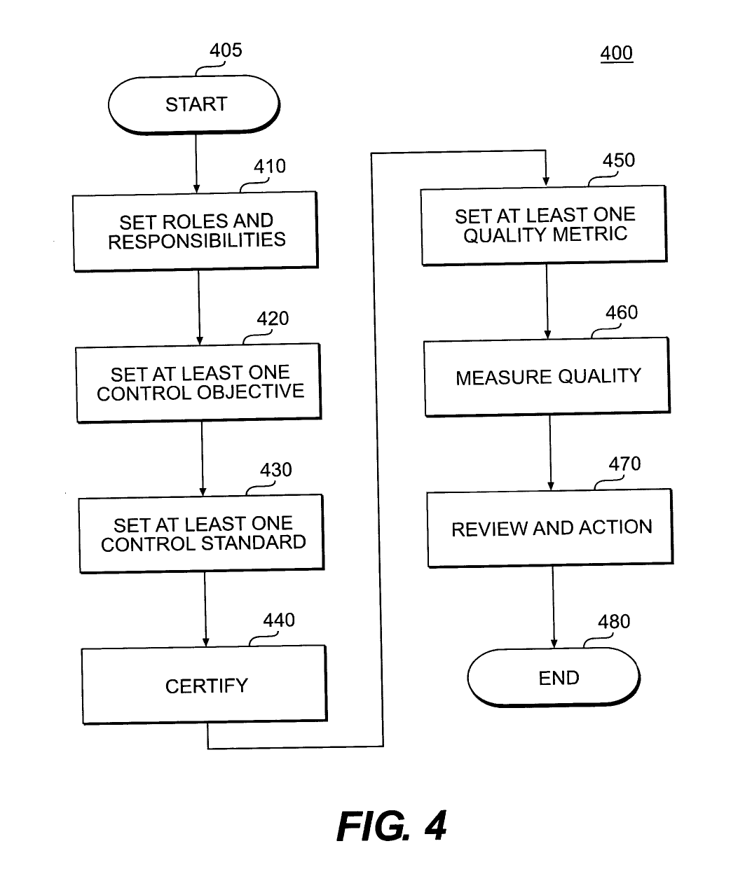

As further shown in FIG. 3, the operational risk assessment processor 310 may include a processing unit 325 and a memory 330. Memory 330 may include one or more operational risk framework software module(s) 335 and an operational risk framework database 340. Operational risk framework software module(s) 335, residing in memory 330, may be executed on processing unit 325 to execute features related to the exemplary methods described herein (including that described with respect to FIGS. 1 and 4) and may access operational risk framework database 340. Operational risk framework database 340 may store data, including requirements, controls and quality metrics, as well as other data such as event data, reports, etc.

Processor 305, 307, and 310 (“the processors”) included in system 300 may be implemented using any suitable computing platform or device, including a personal computer, a network computer, a mainframe, or other similar microcomputer-based workstations or devices. The processors may also comprise any type of computer operating environment, such as hand-held devices, multiprocessor systems, microprocessor-based or programmable sender electronic devices, minicomputers, mainframe computers, and the like. The processors may also be practiced in distributed computing environments, where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 320 may comprise, for example, a local area network (LAN) or a wide area network (WAN). Such networking environments are commonplace in offices, enterprise-wide computer networks, intranets, and the Internet, and are known by those skilled in the art. When a LAN is used as network 320, a network interface located at any of the processors may be used to interconnect any of the processors. When network 320 is implemented in a WAN networking environment, such as the Internet, the processors may typically include an internal or external modem (not shown) or other means for establishing communications over the WAN. Further, in utilizing network 320, data sent over network 320 may be encrypted to ensure data security by using known encryption/decryption techniques.

In addition to utilizing a wire line communications system for network 320, a wireless communications system, or a combination of wire line and wireless may be utilized as network 320 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 300 may also transmit data by methods and processes other than, or in combination with, network 320. These methods and processes may include, but are not limited to, transferring data via, memory sticks, diskette, CD-ROM, facsimile, conventional mail, an interactive voice response system (IVR), or via voice over a publicly switched telephone network.

Referring now to FIG. 4, a flow chart is provided of an exemplary method 400, consistent with an embodiment of the invention. The exemplary method 400 may be performed to provide operational risk management and control. The stages of exemplary method 400 may be implemented using, for example, system 300 (FIG. 3) and are described in greater detail below.

As shown in FIG. 4, exemplary method 400 may begin at starting block 405 where the process is initiated and proceed to stage 410 where processor 310 may set roles and responsibilities for at least one function of an enterprise. By way of example, this stage may include the analysis and drafting of roles and responsibilities of personnel within functions of an enterprise. To facilitate the review and approval of such definitions, a governance structure, such as that presented in FIG. 2, may be provided. In one embodiment, roles and responsibilities may be reviewed and agreed upon by members in one or more committees of the governance structure to provide cross-functionality. Once the roles and responsibilities are finalized, they may be entered by a user (such as user 345) for storage in a database (such as operational risk framework database 340). In one embodiment, draft roles and responsibilities may be stored in database 340 and the review of such roles and responsibilities may be performed online, whereby users (345, 350, etc.) from different business functions are prompted by operational risk framework module(s) 335, executed on processor 310, to enter comments or revisions to such drafts, or add new draft roles and responsibilities before they are approved and finalized by the appropriate committee members, for example. To store draft or final roles and responsibilities, users (345, 350, etc.) may also be prompted to enter the roles and responsibilities into a processor (305, 307, etc.) that transmits the entered data over network 320 to processor 310, which in turn may save the entered roles and responsibilities in database 340, for example.

As described above with respect to FIG. 1, the documentation of roles and responsibilities may ensure that there are appropriate boundaries between functions and that cross-functional reliances (either between functions or between business activities) are clear. The goal may be to specify where a function “begins and ends” and the overall tasks that the function may perform. The roles and responsibilities may comprise a list of distinct and non-overlapping items. Further, the description of each role and responsibility may be a few sentences, for example. In addition, a function may also specify what is considered “in scope” and “out of scope.” This may provide additional information about the limit of the function's activities. A function may also indicate any “cross-functional dependencies” that may describe how the function relies on another function in the performance of its tasks.

From stage 410, where processor 310 sets or defines the roles and responsibilities for the at least one function of the enterprise, exemplary method 400 may advance to stage 420 where processor 310 may define at least one control objective identifying at least one operation risk associated with at least one of the roles and responsibilities. For example, designated users (345, 350, etc.) may be prompted by operational risk framework application 335, executed on processor 310, to define the at least one control objective. A user, such as user 345, may enter the at least one control objective into processor 305 that transmits the entered at least one control objective over network 320 to processor 310, which in turn may save the entered at least one control objective in database 340. As with the setting of roles and responsibilities, control objectives may also be reviewed and finalized online using system 300 before they are finally stored and set in database 340.

Consistent with an aspect of the invention, the specification of control objectives may ensure that the operational risks within any particular role and responsibility are identified. Control objectives may be linked explicitly to a role and responsibility. Further, control objectives may be a description of no more than a few sentences, for example, that identify an operational risk that a function is trying to address through the application of the corresponding control standard. In accordance with one embodiment, explanatory notes may be used to provide additional information regarding a control objective. This may facilitate the certification process and, in particular, the self-certification process by users.

Following stage 420, exemplary method 400 may continue to stage 430 where processor 310 may set at least one control standard describing, for example, a measure to be taken to achieve the at least one control objective. For example, a user 345 may be prompted by operational risk framework application 335, executed on processor 310, to define the at least one control standard. User 345 may enter the at least one control standard into processor 305 that transmits the entered at least one control standard over network 320 to processor 310, which in turn may save the entered at least one control standard in database 340. Any necessary review and analysis of control standards may also be conducted online using system 300, before each control standard is set and saved in database 340.

As described above with respect to FIG. 1, control standards may define the specific expectations that should be met in the performance of a function's activities with regard to operational risk management and control. They may define the control that may be performed without specifying how that control is to be accomplished (i.e., they may be process independent). The control standards may be clearly defined in a manner that is capable of being well understood and rigorously applied. The control standards may comprise questions that can be answered, for example, with either a “yes” (e.g., control is being applied) or a “no” (e.g., control is not being applied for a specified reason) during certification. Each control standard may be linked to a control objective as they may be the specific measures being taken to achieve the goal set by the control objective.

Moreover, in order to address the specific control risks related to financial reporting as required by SOX 404, a standard set of financial statement assertions (for example, those included in the final PCAOB rules (Mar. 9, 2004) for auditors performing SOX 404 attestation work) may be used to specify the risks of financial misstatements. Thus, a linkage may also be made between the control standards and a set of financial statement assertions to ensure that the risks related to financial misstatements have been sufficiently identified and addressed. In addition, each of the control standards may be linked to all significant accounts and disclosures in the enterprise's financial statements in order to allow for an assessment of internal control over financial reporting.

After processor 310 defines the at least one control standard describing the measure to be taken to achieve the at least one control objective in stage 430, exemplary method 400 may proceed to stage 440 where processor 310 may certify using the at least one control objective and the at least one control standard. As disclosed herein, certification may include self-certification by a user (the “certifier”). Self-certification may be carried out by all necessary personnel within the business functions or groups of an enterprise on a periodic basis (e.g., quarterly).

For example, a certifier 350 may be prompted by operational risk framework application 335, executed on processor 310, to answer the at least one control standard question. Certifier 350 may enter the answer to the at least one control standard question into processor 307 that transmits the entered answer over network 320 to processor 310, which in turn may save the entered answer in database 340. As further described below, the responses from certifiers may subsequently be accessed from the database and reviewed for purposes of quality measurement and risk assessment, for example. The review of self-certification responses may be carried out by one or more managers or other assigned individuals (a “signatory”). To facilitate the self certification and review process, one or more graphical user interfaces (GUIs) may be generated by software module(s) 335 for display at a user's processor (305, 307, etc.). Such GUIs, examples of which are further described below with reference to FIGS. 5A-5D, may provide a structured and efficient means by which individuals across all functions of an enterprise may participate and conduct certification.

Referring again to FIG. 4, from stage 440 where processor 310 certifies using the at least one control objective and the at least one control standard, exemplary method 400 may advance to stage 450 where processor 310 may set at least one quality metric related to the quality of the at least one control standard. Quality metrics may be entered, reviewed and approved online using a process similar to that described above for requirements and standard setting. For example, one or more users 345, 350, etc. may be prompted by operational risk framework application 335, executed on processor 310, to define the at least one quality metric, or comment or revise an existing draft quality metric. The user (e.g., user 345) may enter the at least one quality metric or a revision to an existing metric into processor 305, that transmits the entered data over network 320 to processor 310, which in turn may save the entered quality metric in database 340. While the exemplary method of FIG. 4 shows stage 450 being performed after stage 440 (certification), it may in fact be performed before stage 440.

As described above with respect to FIG. 1, quality metrics may be specific trackable events that help provide an indication of potential risk levels in a particular business function or area. Accordingly, quality metrics may provide a “cross-check” on the quality of the performance of the controls specified in the control standards. Quality metrics, for example, may comprise two types, those that may be quantitative in nature (e.g., number of exception breaks) and those that may be qualitative in nature (e.g., an assessment of the quality of an analytical review). The quality metrics may be measured independently of the response to the control standard and each quality metric may be linked to a specific control standard.

Once processor 310 sets the at least one quality metric in stage 450, exemplary method 400 may continue to stage 460 where processor 310 may analyze and measure quality using the at least one quality metric. For example, the quality metrics may be collected on a periodic basis (e.g., monthly, etc.) to provide operational risk assessments in addition to the one provided by stage 440. In addition, internal and external operational risk events may be captured on a periodic basis (e.g., daily for internal events and ad hoc for external events) in processor 310, entered into database 340, and analyzed in stage 460. This may provide additional information for the review or assessment of risk (stage 470) which may be made by application 335. In this stage, and as described above with reference to FIG. 1, when control processes are found to be lacking or informal, appropriate action may be taken, such as: filling the control gaps through the development of additional control standards (stage 130); accepting the risk associated with the control gap based on a cost/benefit analysis after a dispensation request (stage 135); and/or taking any other or additional actions to improve control processes (stage 140). Examples of additional actions include adding more resources (human or technology-based) to improve the control process or monitoring capability, or changing business operation procedures. Reporting may then be provided to senior management. Following stage 470, the exemplary method 400 may then end at stage 480, as illustrated in FIG. 4.

As will be appreciated by those skilled in the art, FIG. 4 is an exemplary embodiment and provided for purposes of illustration. The order of the stages in FIG. 4 may be modified and/or new or additional stages may be added to the exemplary method, consistent with this disclosure and the needs of users.

In accordance with an aspect of the present invention, FIGS. 5A through 5D show exemplary screen shots for performing certification. The exemplary screen shots comprise GUIs which may be generated by, for example, operational risk framework application 335 for display on a user's processor or terminal. These GUIs may solicit a user to provide an answer to the at least one control standard question for self-certification. Consistent with one embodiment, the self-certification process may occur on a periodic basis (e.g., quarterly) and may be managed using the operational risk module(s) 335, which may include secure, web-based application(s) to facilitate certification online. Based on the received responses, operational risk framework application 335 may perform operational risk management and control, consistent with embodiments of the invention as described above.

As disclosed herein, the control standards may be assigned to named individuals (i.e., certifiers) who are required to answer the questions during the self-certification process. This allows for the identification of gaps in meeting an enterprise's control expectation. Each certifier may respond with one of a predetermined set of possible answers. By way of example, one of the following set of responses may be entered by a certifier: compliant; non-compliant with action plan; non-compliant with dispensation requested; and non-compliant because not applicable.

Referring to FIG. 5A, an example of user interface 510 is provided in which a certifier from a business function (Legal) has indicated that they have complied with an applicable control standard (e.g., “Are entries to Lexidia updated on a regular basis?”). To facilitate the certifier review and response, user interface 510 may include a control objective associated with the control standard; in this case, “To ensure management is provided with a timely and accurate record of material outstanding litigation, regulatory investigations and other dispute resolution proceedings.” As further shown in FIG. 5A, a comment field may be provided to enable a certifier to add comments to his/her response.

FIG. 5B illustrates another exemplary user interface 520. In this example, a certifier has indicated that they have not complied with an applicable control standard (e.g., “Is there a management process to monitor adherence to credit risk limits?”). User interface 520 includes a control objective associated with the control standard; in this case, “Ensure all transactions are within market and credit risk limits or that any limit breaches are authorized in accordance with the internal policies.” In one embodiment, if the certifier indicates non-compliance, then an action-plan must be provided to remedy the non-compliance. As shown in FIG. 5B, a comment field may be provided to state the reasons for the non-compliance and also a separate section is provided in user interface 520 to permit details concerning the action plan to be submitted. This may include fields to attach documents related to the action plan, as well as other applicable data (e.g., action plan due date, responsible person, etc.).

As another option, a certifier may indicate non-compliance but also request dispensation. FIG. 5C illustrates an exemplary interface 530 in which a certifier has indicated non-compliance with a control standard (e.g., “Did GT mgmt receive daily VaR/backtesting figures from MRC?”). In the comment field, the certifier has entered an explanation (e.g., “Not always possible to obtain daily figures”) and has requested dispensation (see lower section of interface 530). In general, when a certifier does not believe a control standard should or can be performed, the certifier may request permission not to apply the standard. To support the certifier's request, he/she may be required to provide a description of the control gap (e.g., “Not required by local market conditions”) and also outline compensating/mitigating controls (e.g., “control 01.03.005 is complied with”). Further, the dispensation may be requested for a time period specified by the certifier.

As another alternative, a certifier may indicate that a control standard is not applicable to the nature of the activities under the responsibility of the certifier. For example, FIG. 5D illustrates a user interface 540 in which a certifier has indicated that a control standard is not applicable. In this case, the certifier should explain why the standard is not applicable or relevant. A non-applicable response may result in a change of the control standards mapping that will cause it to disappear in the next certification cycle, for example.

Further GUIs may be provided to facilitate the self-certification process by certifiers. For example, screen displays may be provided that give a log of all certification items reviewed by a certifier. This log may indicate the status of the certified item and whether, for example, a certifier's response has been reviewed, accepted or rejected by a manager or supervisor.

In order to ensure independence of review, each of the certification responses may be reviewed by at least one manager or a designated individual (a “signatory”). A further signatory may also be provided in the form of, for example, the head of the applicable business group in a cross-functional governance structure (see, e.g., FIG. 2). As with the certifiers, GUIs may be provided for signatories to facilitate the review of self-certification responses. Through these GUIs, signatories may be given the ability to approve, change or reject open certification items, as needed. Responses from a signatory may be collected by a processor (305, 307, etc.) and sent via network 320 for storage in database 340.

An additional feature related to certification that may be provided is a linkage of control standards to specific or individual legal entities of the management structure of an enterprise. For example, in FIG. 5B, a control standard (“Is there a management process to monitor adherence to credit risk limits?”) is linked to specific legal entities (10880 Prop.—New York; FMT Funding I—Wilmington; UBS CardCenter(03)—Glattbrug, etc.) for a business area or group (Global AM or Global Asset Management). Linkages may also be provided for quality metrics. In general, linkages may allow certification to be analyzed on a more granular or specific level within an enterprise, as opposed to the whole of the enterprise.

To provide a further understanding of the scope of the invention, reference will now be made to specific features, examples and implementations. These features and examples should not be viewed as limiting the embodiments of the invention. Instead, substitutions, modifications and additions may be made consistent with the teachings and principles of the invention.

Roles and Responsibilities

As disclosed herein, the documentation of roles and responsibilities may ensure that there are appropriate boundaries between functions within an enterprise and that cross-functional reliance is clear. The goal may be to specify where a function “begins and ends” and the overall tasks that the function performs. A function may explicitly describe the roles and responsibilities through a list of distinct and non-overlapping items. The description of each role and responsibility may comprise a few sentences. A function may also indicate what is considered “in scope” and “out of scope.” This may provide additional information about the limit of the function's activities. A function may also indicate the “cross-functional dependencies,” which may describe how the function relies on other functions in the performance of its tasks. There is no minimum or maximum number of roles and responsibilities that should be associated with any given function. For example, there may be between 4 and 8 per function.

Table 1 illustrates an exemplary roles and responsibilities for a legal function of an enterprise. For example, the legal function may have the following set of basic roles and responsibilities.

TABLE 1

| Example | Description |
|---|---|
| 1. | Advise business/location/function management on legal |
| | issues, including in relation to regulatory matters (in |
| | coordination with compliance) where appropriate. |
| 2. | Advise and assist business/location/function management |
| | in relation to the documentation of transactions and other |
| | commitments and, where appropriate, manage standard |
| | documents. |
| 3. | Manage litigation, other dispute resolution proceedings, |
| | or threatened legal actions and provide advice on provisions |
| | for litigation and similar liability risk and respond to |
| | regulatory requests and client complaints. |
| 4. | Provide corporate secretarial services to group companies |
| | where required. |
| 5. | Provide training and education with respect to relevant legal |
| | and regulatory issues. |
| 6. | Manage, protect, and enforce rights to intellectual property |
| | assets. |
| 7. | Manage external counsel relationships. |

Regarding the example of Table 1, with respect to in scope activities, the legal function may provide advice on financial services legal and regulatory matters (including self-regulation) as well as any other legal area that might give rise to legal or reputational risks or may require legal advice. Legal may also assist with the review and approval of new products and businesses and the authorization of transactions requiring pre-approval. Regarding out of scope activities, the legal function's role may be limited to providing advice to the enterprise on matters that affect the enterprise. The legal function may not provide advice to clients, counterparties, vendors, or employees on personal matters.

With respect to the following specific legal areas, the legal function may not assume primary responsibility but may, in some circumstances, provide advice or arrange for the provision of advice upon request of the business: i) health and safety issues; ii) accounting standards; iii) prudential regulation; iv) environmental issues; v) tax issues; and vi) insurance issues regarding the enterprise as the insured. Regarding cross functional dependencies, in this example, other functions may have a general responsibility to alert the legal function to legal and reputational issues as they become aware of them. Other functions may refer to the legal function any non-standard transaction, contract or document that may have material or unusual legal and reputational implications. Furthermore, many regulatory related matters may be handled in coordination with the compliance function. It may not be possible, a priori, to specify the division of responsibility that may occur in any one specific matter, although a compliance function may have a responsibility to notify the legal function of regulatory enforcement actions. In addition, the legal function may rely on the financial control and group tax to provide the requisite information to the legal function to perform the corporate secretarial function.

Control Objectives

The specification of control objectives may ensure that operational risks within any particular role and responsibility are identified. Consistent with the present invention, control objectives may comprise a description of a few sentences that identify an operational risk that a function is trying to address through the application of specific controls (see, e.g., the control standards as described below).

Consistent with another aspect of the invention, explanatory notes may be used to provide additional information regarding a control objective. The explanatory notes for each control objective may provide additional information to a certifier that help the certifier understand the purpose for the objective and the associated control standards. The level of detail contained in the explanatory notes may vary according to the nature of the control objective and the experience of a person likely to be applying the control.

Each control objective may be explicitly linked to a role and responsibility. In one embodiment, several control objectives can be linked to a single role and responsibility. There is no minimum or maximum number of control objectives that may be associated with any given role and responsibility. For example, there may be between 4 and 8 control objectives per role and responsibility.

Control Standards

Control standards may define the expectations that should be met in the performance of a function's activities with regard to operational risk management and control. Consistent with embodiments of the invention, control standards may define the control that may be performed without specifying how that control is to be accomplished (i.e., they may be independent of the process). Further, control standards may be clearly defined in a manner that is capable of being well understood and rigorously applied. The control standards may be in the form of a question that can be answered with either a “yes” (i.e., control is being applied) or “no” (i.e., control is not being applied for a specified reason).

The control standards may not necessarily need to represent the controls actually applied but may instead specify the targets toward which individuals should aim (this may be the reason for allowing dispensation requests in those instances where the target control level is not being met). Each control standard may be linked to a control objective as they may be the specific measures being taken to achieve the goal set by the control objective. There may be multiple control standards for each control objective. Moreover, there is no minimum or maximum number of control standards that should be associated with any given control objective. For example, there may be between 4 and 8 control standards per control objective and between 150 and 250 control standards may be sufficient to cover any given function.

An exemplary control objective may comprise: “To manage litigation, other dispute resolution proceedings, or threatened legal actions (collectively “claims”) so as to seek to achieve the most advantageous outcome within the parameters of instructions given by business/location/function management and the circumstances of each case.” An exemplary note may comprise: “Responsibilities: Business/location/function management are ultimately responsible for the initiation of claims and for the conduct related to claims, as well as for actions taken to defend claims. Legal is responsible for managing the conduct related to claims, including defense actions, within the parameters of instructions provided by business/location/function management. Authorities: Organization Regulations Appendix Part 1 stipulate the authorizations that must be obtained before litigation can be initiated or a settlement concluded.”

To provide further illustration, Table 2 illustrates exemplary control standards, consistent with the invention:

TABLE 2

| Example | Description |
|---|---|
| 1. | Are procedures in place to accurately record the |
| | material elements of claims, including the parties, counsel, |
| | key allegations, relief sought including damages, if any, |
| | and forum? |
| 2. | Are procedures in place for escalating significant |
| | developments regarding claims within Legal? |
| 3. | Are procedures in place for reporting significant developments |
| | related to claims to senior management? |
| 4. | Has a litigation management group been established in Legal? |
| 5. | Is each claim assigned to a responsible attorney within |
| | the litigation management group? |
| 6. | Is there a procedure for establishing and approving provisions |
| | for litigation matters within Legal that assures appropriate |
| | control of provisioning? |
| 7. | Is Financial Control advised as to the provisions for litigation |
| | matters that are approved within Legal? |
| 8. | Is there a process to reconcile or escalate material differences |
| | of opinion between Legal and Financial Control on the |
| | appropriate provision level? |

Control standards may be designated as “prevent” or “detect” controls or both. Prevent controls may be those that are designed to help prevent an operational risk from occurring in the first place. Detect controls may be those that are designed to help detect when an operational risk event has occurred. For example, these labels may be considered useful as, under SOX 404, the auditors may evaluate whether there is a mixture of prevent and detect controls related to each assertion for each financial disclosure. Thus, one embodiment may include a mixture of prevent and detect control standards related to any particular control objective.

In addition, consistent with an aspect of the invention, controls may be categorized, for example, into SOX 404 relevant (a subset of controls that are operational risk relevant) and non-SOX 404 relevant controls based on their connection to the financial reporting process.

Exemplary SOX 404 Application

The following example relate to an embodiment for applying the above control standards to SOX 404 compliance. While SOX 404 is used in this example, any governmental regulation, public policy, enterprise-wide policy, or rule set may be adhered to. In order to facilitate using the above-described operational risk assessment for an assessment of internal control over financial reporting, the following additional “linkages” may be made. First, each control standard may be linked to one or more of five standard financial statement assertions specified in the PCAOB rule (e.g., existence/occurrence; valuation/measurement; completeness; rights and obligations; presentation and disclosure). This may allow the design to meet the documentation requirements and helps facilitate an assessment of design effectiveness required by SOX 404. Second, each control standard may also be linked to one or more of five specific transaction stages (or process steps) specified in the PCAOB rule (i.e., initiation, authorization, processing, recording, reporting.) This may also allow the design to meet the documentation requirements and helps facilitate an assessment of design effectiveness required by SOX 404. Third, each control standard may be linked to a prevent or detect control label in order to identify which controls are designed to prevent failures from occurring and which controls are designed to detect failures that have occurred. This may help facilitate an assessment of design effectiveness and allows for a more robust assessment of operating effectiveness.

These labels, particularly the assertions, may provide a key step in the development of the “taxonomy of risk”. For example, it may be possible to identify that a control relevant for the existence assertion in the front office of a private banking area or the valuation assertion for the credit risk area of a structured products area has failed and thus contributed to the existence of an operational risk event. Based on this knowledge, it may then be possible to compare your own controls against the controls that failed to assess your own susceptibility. This may provide a structured way of learning from external events that is currently missing from conventional operational risk analysis despite the valuable work done in reports on individual cases.

Moreover, each control standard may be linked to financial statement reporting lines (i.e., a specific disclosure item—whether a figure for an account or a relevant note—contained in the financial statements) where the control helps prevent misstatements. The linkages between control standards and financial reporting lines may be sufficient to cover a “significant” portion of the balance sheet and profit and loss disclosures for a “significant” number of a bank's legal entities as required by SOX 404.

Once these linkages are made, a framework sufficient for assessing internal control over financial reporting may have been created. It may then be possible to layer an assessment of internal control over financial reporting on top of the operational risk assessment process described above. That is, the cross-functional governance structure described above could not only identify the control failures, but then it could, through the linkages built to the financial reporting lines, assess their importance to financial reporting in order to determine if the control failure should amount to a deficiency, significant deficiency, or material weakness according to the SOX 404 requirements.

It should be noted that there are still some additional elements that may be needed, for example, for both SOX 404 compliance (e.g., an evaluation of company level controls, an evaluation of the period-end reporting process, review of reliance on outsourcing providers) and for Basel II operational risk (e.g., decisions about risk control and risk mitigation, an evaluation of business continuity and contingency planning) that would need to be added to these basic processes. However, these are incremental additions to the basic process outlined above.

Quality Metrics

Although the control standards (described above) and the self-certification process (described below) may determine whether controls are being performed, they may not necessarily indicate the quality of the performance of the controls. Thus, the self-certification process may be supplemented with a quality metric tracking process. The quality metric tracking process may identify issues related to the quality of the performance of the control standards. For example, an individual certifier could answer “yes” to the fact that reconciliations are being performed, but the metric may identify that there are 100,000 reconciliation breaks that indicate that the quality of the performance of the control may be questionable. In addition, the quality metrics may help track risk levels during the period between the certification of a control standard.

Quality metrics may comprise specific trackable events that help provide an indication of potential risk levels in a particular area. Quality metrics may comprise the following two types:
1) Quantitative—these metrics may be driven by formula and may result in a specific number, for example, the number of breaks or deadlines not met. Issues with regard to these metrics may include:
   a) There may be a means to validate the inputs into the calculation process and controls to ensure the accurate capture of the data inputs;
   b) The model used to calculate the metric may be transparent and reviewed and signed off as all the operational risk documentation are signed-off; and
   c) Procedures for changing and updating the metric calculation may be formalized and include the authorization of a given business group chief risk officer (CRO);
2) Qualitative—these metrics may involve more subjective evaluations, (for example, an assessment of the quality of analytical review or a commentary intended to explain a financial reference). Issues with regard to these metrics may include:
   a) There may be independence in either the assessment of the metric or in the review of the metric rating, for example, the metric value may be solely determined by the individual responsible for the activity being assessed; and
   b) The independence in the assessment or review may be defined and agreed including, for example, authorization by a given business group CRO.

Each control standard may be supported by a metric even if the connection between a given control standard and a given metric may not be a strong correlation between the two. However, the metrics are intended to provide supplemental risk indicators that may help identify when further investigation into a potential control standard failure (either in design or in performance) may be warranted.

In order to develop the metrics, each function may define its risk measures. Many functions may have existing risk measures that they use already within their function, for example an operation's function may produce key risk indicators including, for example, the number of fails, number of open items on the cash and securities reconciliation, and risk positions requiring provisions. These may comprise the type of metrics that should be used to measure the quality to which the control standards are being performed. In other cases where functions do not have metrics, they may need to be devised by considering the risks inherent within the function, and then identifying suitable measures, either qualitative or quantitative, for example.

Every metric may be linked to one or more control objectives/control standards. If the metrics have been developed to measure the key risks within each function, the mapping may be relatively straightforward. This may be because the control objectives were devised by identifying the key risks in a function (e.g. “what could go wrong”) and the control standards were devised to mitigate these risks identified in the control objectives. As a result, in many cases, a metric may measure the quality of all control standards under a control objective.

The metrics may not be evidence that the control standard has been performed. Instead, the goal for the metrics may be to provide a supplementary indicator of risk levels that can serve as a “cross-check” on, for example, the self-certification process as described below. Thus, the metrics may help identify when additional questions and investigation into the self-certification process (for example, were the questions not understood or are the questions no longer appropriate) may be appropriate.

The following examples demonstrate a process and a rational for choosing certain metrics for defined control objectives or control standards:

### EXAMPLE 1

### Function: Controlling & Accounting

Control Objective:

To ensure a timetable for all-financial reporting is prepared, reviewed, signed off and distributed to the respective stakeholders in an accurate and timely manner.

Control Standards:

1) Is a monthly reporting calendar in line with the corporate center calendar in place, which outlines the activities and deadlines for completing and submitting all financial information to various stakeholders?

2) Is the reporting calendar communicated to the relevant people, and is it published on the intranet site?

Potential Metric:

The quality of the control standards can be measured by the “Number of forced closures on the Central Accounting System” or “Number of times the closed entities are subsequently unlocked in the Central Accounting System” This is because all legal entity accounts are required to be signed off by day seven (7) after month end, at this point the entity accounts are locked. Thus, if a legal entity is not signed off by this date, the Central Accounting System may force closure of the legal entity accounts.

### EXAMPLE 2

### Function: Controlling & Accounting

Control Objective:

To ensure the local accountant/controller reviews the monthly closing work performed by the competence centre.

Control Standard:

1) Are all variances explained and reported by the respective competence center/account owner?

2) Did the accountant/controller challenge the competence centers/account owners on their comments?

3) Before giving the Central Accounting System sign off, has the accountant confirmed with the competence centre that financial information is compliant with internal and external accounting policies?

4) If the local accounting system is not closed upon the Central Accounting System submission, is the general ledger reconciled to international accounting standards and U.S. accounting standards and adjustments made where necessary?

Potential Metrics:

1) For control standards 1 and 2, the effectiveness of the controls may be measured by a metric such as “the total of Amounts under investigation.” This is because all accounts have owners that are responsible for their reconciliation and the un-reconciled amounts within the accounts are calculated as the “Amount under investigation”.

2) For control standards 3 and 4, it can be measured by “Number of times the closed entities are subsequently unlocked in GCRS” using the logic described above.

### EXAMPLE 3

### Function: Chief Risk Officer

Control Objectives:

1) Non-standard risks: Accurate quantification of non-standard risks.

2) Exceptional Trade Approval: Ensure changes to the risk profile of the enterprise, created through the potential execution of an exceptional transaction, are within the risk appetite of the enterprise.

Potential Metrics:

All transactions may be recorded accurately and timely in the approved risk management systems. When exceptional trades are conducted that cannot be managed within the existing systems, exceptional processes may be required to monitor them. The maintenance of these transactions outside approved systems may create a higher risk of incorrect recording and processing. As a result, the level of potential risk inherent in exceptional trades can be measured by for example “the number of trades booked outside approved risk management systems”. Thus, the higher the number, the higher the potential risk of inaccurate recording and processing.

Metrics may be collected by a function. There may be a process for ensuring the integrity of the metrics in order to ensure their independent and accurate reporting. In some cases, this may occur by having the metrics collected by the same people who are performing the related control standards and then having those metrics signed-off by their management, for example. In other cases, an independent process or area may collect the metrics. In all cases, the measurement of the metric may be subject to review by a control function or by audit.

Certification

The documentation created in, for example, stage 105 may provide the raw material for the self-certification process of stage 115, which in turn may provide one form of operational risk assessment. Control standards may be assigned to named individuals (“certifiers”) within the enterprise who may be required to answer the control standard questions during the self-certification process. In general, on a periodic basis (e.g., quarterly), the certifiers may be asked to respond to the control standard questions and line managers, for example, may review the answers to assess the performance of controls.

It may not be possible to a priori specify who should be assigned the questions. This is a determination that may be made by each function in each business group based upon the nature of its activities and organizational structure. However, the person answering the question may be in a position to adequately assess whether the control standard is being performed and, if not, why.

When a certifier is assigned to a control standard this may occur at a specific are in the enterprise's management hierarchy and for specific legal entities owned by the enterprise. An individual may be assigned to more than one control standard, however, it may not be anticipated that any one person will be responsible for answering a large number of control standard questions. This may help ensure that the control standard questions are answered by those who are close to the controls actually being performed. Multiple individuals may certify against one individual control standard. For example, this may be likely when a control standard is being applied in different legal entities or at a different level in the management hierarchy.

Control standards that may be applied to a particular enterprise may differ given the nature of the entity. This applies, for example, to both SOX 404 compliance and for general operational risk analysis.

In one embodiment, each person assigned to a control standard may respond to the corresponding control standard question, for example, with one of the following five exemplary responses:
1) Compliant: Which may indicate that the control standard is being performed as required. The certifier is complying with the control standard for all legal entities and at all management hierarchy levels for which the individual is responsible (i.e., if the certifier is responsible for 10 legal entities and only performs the control for 9 of them, then the response may be non-compliant).
2) Non-compliant: Which may indicate that the control standard is not being performed. An action plan may be provided to remedy the non-compliance. The action plan does not necessarily need to be formulated at the same time that the non-compliant certification occurs. Further, action plans may not be stored and may not be tracked in the operational risk application.
3) Dispensation Requested: Which may indicate that the certifier does not believe that the control standard should or can be performed and is requesting permission not to apply the standard for a certain time period. The certifier may provide a description of the gap and outline the mitigating controls that are in place.
4) Dispensation Received: Which may indicate that the certifier has already received permission not to apply the control standard based on a prior dispensation request. The certifier may either reconfirm this or provide a different response based on a change in the underlying circumstances.
5) Not Applicable: Which may indicate that the control standard may not be relevant for the nature of the activities under the responsibility of the certifier. The certifier may explain why this is the case or is not relevant for the legal entities or management hierarchy level. A “not applicable” response may result in a change in the control standards mapping that may cause it to disappear in the next certification cycle.

For purposes of operational risk management and control, for example, the responses to the control standard questions may first be reviewed by the line manager of the answering certifier. The line manager may confirm the performance of the control. After the line manager's review, the business group cross-function governance structure may review the response, for example, on an exception basis. Additional reviews (e.g., by the finance function) may be necessary for SOX 404 compliance.

The self-certification process may occur periodically, for example, on a quarterly basis or any other basis (monthly, semi-annually, etc.). For those controls that are only applied at a certain period during the year (e.g., year-end), the certifier may respond with “not applicable” during any period in which the control is not applied. Although the self-certifications may occur at a point in time, they may be intended to cover the entire quarter. Thus, certifiers may be answering whether the control has been performed during the period from the beginning of the quarter to the point at which the certification occurs and will be applied during the period from the certification point to the end of the quarter. For those controls that are only applied at a certain period during the year (e.g., year-end), the certifier may respond with “not applicable” during any quarter in which the control is not applied. A process for obtaining a dispensation request or approval of an action plan may be established. This process, however, may include a review by, for example, a line manager of the certifier seeking the dispensation request and the cross-function governance structure.

The self-certification process may be managed using an operational risk data entry application (see, e.g., module 335 in FIG. 3) that may function as a sub-application of the operational risk framework software application. This application may be able to produce reports that identify the responses to the control standard questions and the metric values. A separate assessment and reporting process may be defined outside the application to ensure, for example, that there may be adequate scope for operational risk management and control decisions and for SOX 404 assessments to be made.

Measure Quality

In addition to self-certification, other assessment processes may also occur. For example, quality metrics and internal and external event data may be collected on a periodic basis to provide additional operational risk assessments.

All of this information may be discussed within a cross-functional governance structure (i.e., a committee including representatives of all functions that have certified against control standards) along with the certification results in order to provide an overall assessment of operational risk, to determine the management and control actions to be taken, and the appropriate information to report to senior management or other relevant entities.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing operational risk management and control, the method comprising:
defining roles and responsibilities for at least one function of an enterprise;
defining at least one control objective identifying at least one operation risk associated with at least one of the roles and responsibilities;
defining at least one control standard describing a measure to be taken to achieve the at least one control objective; and
certifying adherence to the at least one control standard to meet the at least one control objective for the at least one role and responsibility.

2. The method of claim 1, wherein defining the roles and responsibilities comprises creating a set of non-overlapping elements, each of the non-overlapping elements respectively describing an individual role and responsibility.

3. The method of claim 1, wherein defining the roles and responsibilities comprises indicating a cross-functional dependency describing how the at least one function relies on another function within the enterprise.

4. The method of claim 1, wherein defining the at least one control objective comprises providing at least one explanatory note with information regarding the at least one control objective to facilitate certification.

5. The method of claim 1, wherein defining the at least one control standard comprises indicating an expectation to be met in the performance of an activity related to the at least one function.

6. The method of claim 1, wherein defining the at least one control standard comprises defining the at least one control standard in the form of a question.

7. The method of claim 6, wherein certifying adherence to the at least one control standard comprises performing, on a periodic basis, a self-certification process that includes prompting a certifier of the enterprise to respond to the at least one control standard question.

8. The method of claim 7, wherein the certifier may respond to the prompting by indicating whether compliance with the at least one control standard has been met.

9. The method of claim 8, wherein certifying further comprises performing a review of a response from a certifier for purposes of quality measurement and risk assessment.

10. The method of claim 7, further comprising defining at least one quality metric to measure a quality of the performance of the at least one control standard.

11. The method of claim 10, wherein the at least one quality metric is one of quantitative and qualitative.

12. The method of claim 10, further comprising collecting internal and external operational risk event data and performing a risk assessment that includes a review of the results of the periodic certification and the at least one quality metric.

13. The method of claim 12, wherein the risk assessment is performed by a cross-function governance structure for the enterprise.

14. The method of claim 12, further comprising using the risk assessment to generate a report to senior management of the enterprise.

15. The method of claim 1, wherein defining the at least one control standard comprises linking the at least one control standard to one or more categories to facilitate an assessment of control over financial reporting mandated by at least one of the Sarbanes-Oxley Act of 2002 Section 404 (“SOX 404”) and the Basel II accord.

16. The method of claim 1, further comprising linking the at least one control standard to a standard financial statement assertion, the standard financial statement assertion comprising one from the group of: existence/occurrence, valuation/measurement, completeness, rights and obligations, and presentation and disclosure.

17. The method of claim 1, wherein defining the at least one control standard comprises linking the at least one control standard to a financial statement assertion.

18. The method of claim 1, wherein certifying adherence to the at least one control standard comprises assigning the at least one control standard to an individual responsible for complying with the control standard.

19. The method of claim 1, wherein certifying adherence to the at least one control standard comprises receiving, on a periodic basis, an answer to the at least one control standard from an individual associated with the enterprise.

20. The method of claim 19, wherein receiving an answer comprises receiving an answer indicating that the individual is compliant or non-compliant with the at least one control standard.

21. The method of claim 1, wherein certifying adherence to the at least one control standard comprises:
receiving a self-certification response to the at least one control standard from an individual associated with the enterprise; and
reviewing the results of the self-certification response, the review being performed by a manager of the individual to assess the performance of the at least one control standard.

22. The method of claim 1, further comprising defining at least one quality metric to measure a quality of the performance of the at least one control standard.

23. The method of claim 22, wherein the at least one quality metric comprises a trackable event that provides an indication of a potential risk level.

24. The method of claim 22, wherein the at least one quality metric is one of quantitative and qualitative.

25. The method of claim 22, further comprising measuring quality using the at least one quality metric to provide a cross-check on certifying adherence to the at least one control standard.

26. A system for providing operational risk management and control, the system comprising:
a memory storage for maintaining a database; and
a processing unit coupled to the memory storage, wherein the processing unit is operative to:
set roles and responsibilities for at least one function of an enterprise;
set at least one control objective identifying at least one operation risk associated with at least one of the roles and responsibilities;
set at least one control standard describing a measure to be taken to achieve the at least one control objective; and
certify adherence to the at least one control standard to meet the at least one control objective for the at least one role and responsibility.

27. The system of claim 26, wherein to set the roles and responsibilities the processing unit is further operative to create a set of non-overlapping elements, each of the non-overlapping elements respectively describing an individual role and responsibility.

28. The system of claim 26, wherein to set the roles and responsibilities the processing unit is further operative to indicate a cross-functional dependency describing how the at least one function relies on another function within the enterprise.

29. The system of claim 26, wherein to set the at least one control objective the processing unit is further operative to provide at least one explanatory note with information regarding the at least one control objective to facilitate certification.

30. The system of claim 26, wherein to set the at least one control standard the processing unit is further operative to indicate an expectation to be met in the performance of an activity related to the at least one function.

31. The system of claim 26, wherein to set the at least one control standard the processing unit is further operative to set the at least one control standard in the form of a question.

32. The system of claim 31, wherein to certify adherence to the at least one control standard the processing unit is further operative to perform, on a periodic basis, a self-certification process that includes prompting a certifier of the enterprise to respond to the at least one control standard question.

33. The system of claim 32, wherein the certifier may respond to the prompting by indicating whether compliance with the at least one control standard has been met.

34. The system of claim 33, wherein to certify the processing unit is further operative to facilitate a review of a response from a certifier for purposes of quality measurement and risk assessment.

35. The system of claim 32, wherein the processing unit is further operative to set at least one quality metric to measure a quality of the performance of the at least one control standard.

36. The system of claim 35, wherein the at least one quality metric is one of quantitative and qualitative.

37. The system of claim 35, the processing unit is further operative to collect internal and external operational risk event data and facilitate a risk assessment that includes a review of the results of the periodic certification and the at least one quality metric.

38. The system of claim 37, wherein the risk assessment is performed by a cross-function governance structure for the enterprise.

39. The system of claim 37, wherein the processing unit is further operative to generate a report for senior management of the enterprise based on the risk assessment.

40. The system of claim 26, wherein to set the at least one control standard the processing unit is further operative to link the risk assessment the at least one control standard to one or more categories to provide an assessment of control over financial reporting mandated by at least one of the Sarbanes-Oxley Act of 2002 Section 404 (“SOX 404”) and the Basel II accord.

41. The system of claim 26, wherein the processing unit is further operative to link the at least one control standard to a standard financial statement assertion, the standard financial statement assertion comprising one from the group of: existence/occurrence, valuation/measurement, completeness, rights and obligations, and presentation and disclosure.

42. The system of claim 26, wherein to set the at least one control standard the processing unit is further operative to link the at least one control standard to a financial statement assertion.

43. The system of claim 26, wherein to certify adherence to the at least one control standard the processing unit is further operative to assign the at least one control standard to an individual responsible for complying with the control standard.

44. The system of claim 26, wherein to certify adherence to the at least one control standard the processing unit is further operative to receive, on a periodic basis, an answer to the at least one control standard from an individual associated with the enterprise, the answer being submitted by the individual using a graphical user interface.

45. The system of claim 44, wherein receiving an answer comprises receiving an answer indicating that the individual is compliant or non-compliant with the at least one control standard.

46. The system of claim 26, wherein to certify adherence to the at least one control standard the processing unit is further operative to:
receive a self-certification response to the at least one control standard from an individual associated with the enterprise; and
facilitate a review of the results of the self-certification response, the review being performed by a manager of the individual to assess the performance of the at least one control standard.

47. The system of claim 26, wherein the processing unit is further operative to set at least one quality metric to measure a quality of the performance of the at least one control standard.

48. The system of claim 47, wherein the at least one quality metric comprises a trackable event that provides an indication of a potential risk level.

49. The system of claim 47, wherein the at least one quality metric is one of quantitative and qualitative.

50. The system of claim 47, wherein the processing unit is further operative to measure quality using the at least one quality metric to provide a cross-check on the certification of adherence to the at least one control standard.

51. A computer-readable medium which stores a set of instructions which when executed performs a method for providing operational risk management and control, the method executed by the set of instructions comprising:
setting roles and responsibilities for at least one function of an enterprise;
setting at least one control objective identifying at least one operation risk associated with at least one of the roles and responsibilities;
setting at least one control standard describing a measure to be taken to achieve the at least one control objective; and
certifying adherence to the at least one control standard to meet the at least one control objective for the at least one role and responsibility.

52. The computer-readable medium of claim 51, wherein setting the roles and responsibilities comprises creating a set of non-overlapping elements, each of the non-overlapping elements respectively describing an individual role and responsibility.

53. The computer-readable medium of claim 51, wherein setting the roles and comprises indicating a cross-functional dependency describing how the at least one function relies on another function within the enterprise.

54. The computer-readable medium of claim 51, wherein setting the at least one control objective comprises providing at least one explanatory note with information regarding the at least one control objective.

55. The computer-readable medium of claim 51, wherein setting the at least one control standard comprises indicating an expectation to be met in the performance of an activity related to the at least one function.

56. The computer-readable medium of claim 51, wherein setting the at least one control standard comprises setting the at least one control standard in the form of a question.

57. The computer-readable medium of claim 56, wherein certifying adherence to the at least one control standard comprises performing, on a periodic basis, a self-certification process that includes prompting a certifier of the enterprise to respond to the at least one control standard question.

58. The computer-readable medium of claim 57, wherein the certifier may respond to the prompting by indicating whether compliance with the at least one control standard has been met.

59. The computer-readable medium of claim 58, wherein certifying further comprise reviewing a response from a certifier for purposes of quality measurement and risk assessment.

60. The computer-readable medium of claim 57, wherein the method further comprises setting at least one quality metric to measure a quality of the performance of the at least one control standard.

61. The computer-readable medium of claim 60, wherein the at least one quality metric is one of quantitative and qualitative.

62. The computer-readable medium of claim 60, wherein the method further comprises collecting internal and external operational risk event data and performing a risk assessment that includes a review of the results of the periodic certification and the at least one quality metric.

63. The computer-readable medium of claim 62, wherein the risk assessment is performed by a cross-function governance structure for the enterprise.

64. The computer-readable medium of claim 62, wherein the method further comprises generating a report for senior management of the enterprise based on the risk assessment.

65. The computer-readable medium of claim 51, wherein setting the at least one control standard comprises linking the risk assessment the at least one control standard to one or more categories to provide an assessment of control over financial reporting mandated by at least one of the Sarbanes-Oxley Act of 2002 Section 404 (“SOX 404”) and the Basel II accord.

66. The computer-readable medium of claim 51, wherein the method further comprises linking the at least one control standard to a standard financial statement assertion, the standard financial statement assertion comprising one from the group of: existence/occurrence, valuation/measurement, completeness, rights and obligations, and presentation and disclosure.

67. The computer-readable medium of claim 51, wherein the method further comprises linking the at least one control standard to a financial statement assertion.

68. The computer-readable medium of claim 51, wherein certifying adherence to the at least one control standard comprises assigning the at least one control standard to an individual responsible for complying with the control standard.

69. The computer-readable medium of claim 51, wherein certifying adherence to the at least one control standard comprises receiving, on a periodic basis, an answer to the at least one control standard from an individual associated with the enterprise.

70. The computer-readable medium of claim 69, wherein receiving an answer comprises receiving an answer indicating that the individual is compliant or non-compliant with the at least one control standard.

71. The computer-readable medium of claim 51, wherein certifying adherence to the at least one control standard comprises:
receiving a self-certification response to the at least one control standard from an individual associated with the enterprise; and
reviewing the results of the self-certification response, the review being performed by a manager of the individual to assess the performance of the at least one control standard.

72. The computer-readable medium of claim 51, wherein the method further comprises setting at least one quality metric to measure a quality of the performance of the at least one control standard.

73. The computer-readable medium of claim 72, wherein the at least one quality metric comprises a trackable event that provides an indication of a potential risk level.

74. The computer-readable medium of claim 72, wherein the at least one quality metric is one of quantitative and qualitative.

75. The computer-readable medium of claim 72, wherein the method further comprises measuring quality using the at least one quality metric to provide a cross-check on the certification of adherence to the at least one control standard.
